(19) United States
(12) Patent Application Publication
(10) Pub. No.: US 2015/0064659 A1
(43) Pub. Date: Mar. 5, 2015

(54) METHODS FOR MOTOR VEHICLE DRIVER RISK REDUCTION AND DEVICES THEREOF

(71) Applicant: Interactive Driving Systems, Inc., Cape May Court House, NJ (US)

(72) Inventor: Edmund S. Dubens, Cape May Court House, NJ (US)

(73) Assignee: Interactive Driving Systems, Inc., Cape May Court House, NJ (US)

(21) Appl. No.: 14/017,015

(22) Filed: Sep. 3, 2013

(51) Int. Cl. G09B 5/00

(52) U.S. Cl. CPC G09B 5/00
USPC 434/65

(57) ABSTRACT

A method, non-transitory computer readable medium, and a driver intervention device that obtains an indication of a risk event associated with a motor vehicle driver. At least one human factor of the motor vehicle driver that contributed to the risk event is retrieved based on a correlation with the indicated risk event. At least one recommended intervention is determined for the motor vehicle driver based on a match of the at least one human factor of the motor vehicle driver. The determined at least one recommended intervention is output to a computing device associated with the motor vehicle driver.

### FIELD

This technology generally relates to methods and devices for motor vehicle driver risk reduction and, more particularly, methods for reducing the occurrence of risk events through recommended interventions and devices thereof.

### BACKGROUND

Safety is a significant concern for motor vehicle drivers and fleet vehicle operators managing a plurality of drivers associated with an organization. Incidents and collisions result in injuries to drivers and passengers, damage to vehicles and other property, and increased insurance cost. For commercial or fleet vehicle drivers risk events, such as incidents, collisions, and traffic violations, can result in license suspension or loss and associated inability to maintain employment. Accordingly, both motor vehicle drivers and fleet vehicle operators share a significant interest in increasing safety and reducing the occurrence of risk events.

Currently, motor vehicle driver risk or performance management electronic platforms and web portal systems are available that facilitate communication of performance data to drivers and fleet vehicle operators in an attempt to mitigate motor vehicle driver risk. However, these systems suffer from several drawbacks. For example, these systems do not utilize a comprehensive profile of performance data for each motor vehicle driver. For example, many systems only retrieve data from telematics devices attached to vehicles. Other systems are only capable of considering collision data retrieved from for example insurance companies, brokers, or leasing companies based on submitted claims. Accordingly, these systems lack the performance data necessary to provide an accurate analysis of motor vehicle driver risk or to recommend appropriate or effective interventions to reduce future risk.

Moreover, these systems fail to effectively deliver recommended interventions to motor vehicle drivers in order to mitigate risk. For example, recommended interventions, such as educational or training content, is often delayed with respect to the occurrence of the a risk event and/or not targeted effectively for the motor vehicle driver. Specifically, these systems do not consider human factors, such as behavior or attributes of the motor vehicle driver, that may have lead to a past risk event, and may lead to future risk event, in generating recommended interventions. Accordingly, prior systems are not effective at targeting recommended interventions based on many root causes of risk events and therefore are ineffective at mitigating future motor vehicle driver risk.

### SUMMARY

A method for motor vehicle driver risk reduction includes obtaining, with a driver intervention device, an indication of a risk event associated with a motor vehicle driver. At least one human factor of the motor vehicle driver that contributed to the risk event is retrieved, with the driver intervention device, based on a correlation with the indicated risk event. At least one recommended intervention is determined, with the driver intervention device, for the motor vehicle driver based on a match of the at least one human factor of the motor vehicle driver. The determined at least one recommended intervention is output, with the driver intervention device, to a computing device associated with the motor vehicle driver.

A non-transitory computer readable medium having stored thereon instructions for motor vehicle driver risk reduction comprising machine executable code which when executed by a processor, causes the processor to perform steps including obtaining an indication of a risk event associated with a motor vehicle driver. At least one human factor of the motor vehicle driver that contributed to the risk event is retrieved based on a correlation with the indicated risk event. At least one recommended intervention is determined for the motor vehicle driver based on a match of the at least one human factor of the motor vehicle driver. The determined at least one recommended intervention is output to a computing device associated with the motor vehicle driver.

A driver intervention device includes a processor coupled to a memory and configured to execute programmed instructions stored in the memory including obtaining an indication of a risk event associated with a motor vehicle driver. At least one human factor of the motor vehicle driver that contributed to the risk event is retrieved based on a correlation with the indicated risk event. At least one recommended intervention is determined for the motor vehicle driver based on a match of the at least one human factor of the motor vehicle driver. The determined at least one recommended intervention is output to a computing device associated with the motor vehicle driver.

This technology provides a number of advantages including providing methods, non-transitory computer readable medium, and devices that facilitate improved motor vehicle driver risk management through more effective intervention recommendations. With this technology, performance data associated with motor vehicle drivers is obtained from an increased number of sources allowing for a more accurate and comprehensive risk analysis. Additionally, with this technology interventions are more effectively targeted to motor vehicle drivers based on human factors associated with risk events identified by the analysis of the performance data. Further, with this technology interventions are automatically recommended to motor vehicle drivers to more effectively reduce the risk of a future event.

### BRIEF DESCRIPTION OF THE DRAWINGS

FIG. 1 is a block diagram of an exemplary network environment which incorporates exemplary driver computing devices and performance data source devices coupled to an exemplary driver intervention device;

FIG. 2 is a flowchart of an exemplary method for facilitating motor vehicle driver risk reduction;

FIG. 3 is an exemplary human factor mapping table including exemplary mappings of risk events to human factors associated with the risk events; and

FIG. 4 is an exemplary risk profile of risk levels for risk events and human factors associated with the risk events.

### DETAILED DESCRIPTION

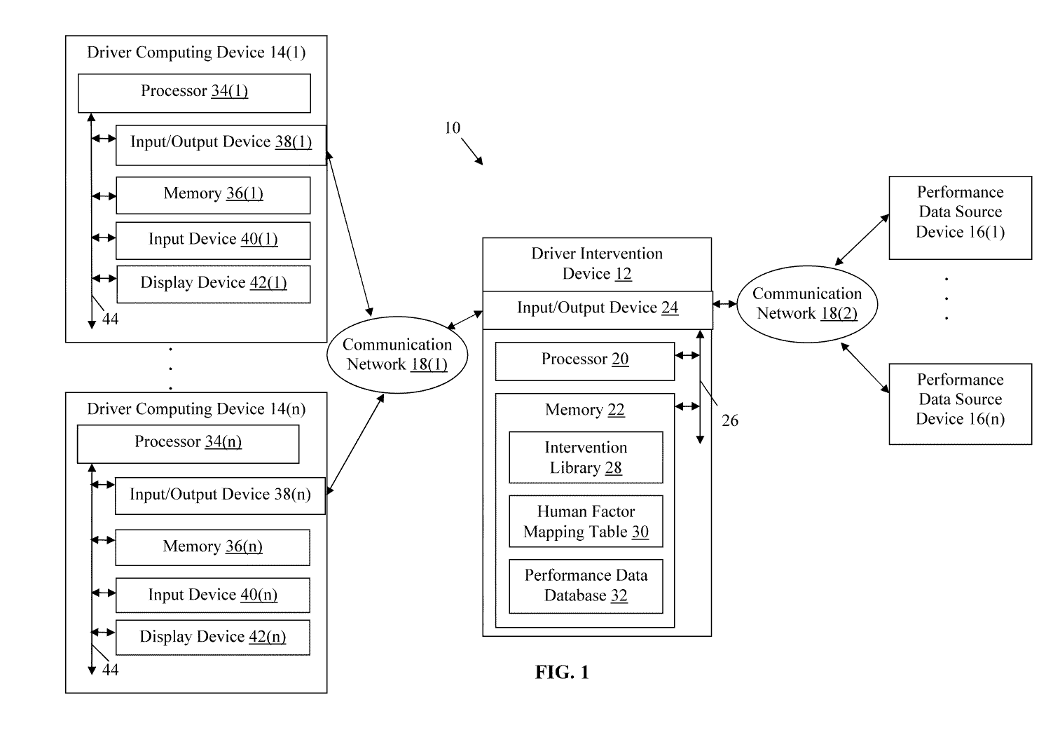

An exemplary network environment 10 with a driver intervention device 12 coupled to driver computing devices 14(1)-14(n) and performance data source devices 16(1)-16(n) by communication networks 18(1)-18(2) is illustrated in FIG. 1, although this network environment 10 can include other numbers and types of systems, devices, and elements in other configurations. While not shown, the network environment 10 also may include additional network components such as routers and switches which are well known to those of ordinary skill in the art and thus will not be described here. This technology provides a number of advantages including methods, non-transitory computer readable media, and devices that facilitate improved motor vehicle driver risk management through more effective intervention recommendations.

The driver intervention device 12 includes a processor 20, a memory 22, and an input/output device 24, which are coupled together by a bus 26 or other link, although other numbers and types of systems, devices, components, and elements in other configurations and locations can also be used. The processor 20 in the driver intervention device 12 executes a program of stored instructions for one or more aspects of the present technology, as described and illustrated by way of the examples herein, although other types and numbers of processing devices and configurable hardware logic could be used and the processor 20 could execute other numbers and types of programmed instructions.

The memory 22 in the driver intervention device 12 stores these programmed instructions for one or more aspects of the present technology as described and illustrated herein, although some or all of the programmed instructions could be stored and executed elsewhere. A variety of different types of memory storage devices, such as a RAM, ROM, floppy disk, hard disk, CD-ROM, DVD-ROM, or other computer readable medium which is read from and written to by a magnetic, optical, or other reading and writing system that is coupled to the processor 20, can be used for the memory 22.

In this example, the memory 22 includes an intervention library 28, human factor mapping table 30, and a performance data database 32, although the memory could include other types and numbers of libraries, tables, databases, and other modules. The intervention library 28 includes recommended interventions, such as educational or training content by way of example only, that can be included or linked to a recommendation sent to a motor vehicle driver user of one of the driver computing devices 14(1)-14(n), as described and illustrated in more detail later, although the library can comprise other types and amounts of other information which can be provided.

The human factor mapping table 30 includes mappings of human factors to risk events, although the table can include other types of correlations. The human factor mapping table 30 is used to identify human factor(s) associated with risk events. The driver intervention device 12 then uses the identified human factor(s) to identify intervention(s) stored in the intervention library 28 and to automatically generate recommended interventions for a motor vehicle driver user of one of the driver computing devices 14(1)-14(n), as described and illustrated in more detail later.

The performance data database 32 is a repository for performance data obtained from the performance data source devices 16(1)-16(n) and associated with a motor vehicle driver, also as described and illustrated in more detail later, although the database can store other types and amounts of data. In other examples, the memory 22 may store other information in other formats and the information stored in the intervention library 28, human factor mapping table 30, and performance data database 32 can be stored elsewhere as well.

The input/output device 24 in the driver intervention device 12 is used to operatively couple and communicate between the driver intervention device 12, the driver computing devices 14(1)-14(n), and the performance data source devices 16(1)-16(n) via the communication networks 18(1)-18(2), although other types and numbers of connections and configurations can also be used. By way of example only, the communication networks 18(1)-18(2) can include one or more local area networks or wide area networks, for example, and can use TCP/IP over Ethernet and industry-standard protocols, including hypertext transfer protocol (HTTP) and secure HTTP (HTTPS), although other types and numbers of communication networks, such as a direct connection, modems and phone lines, e-mail, and wireless and hardwire communication technology, each having their own communications protocols, can also be used.

The driver computing devices 14(1)-14(n) in this example each include a processor 34(1)-34(n), a memory 36(1)-36(n), an input/output device 38(1)-38(n), an input device 40(1)-40(n), and a display device 42(1)-42(n), which are coupled together by a bus 44(1)-44(n) or other link. The driver computing devices 14(1)-14(n) can also have other numbers and types of systems, devices, components, and elements in other configurations and locations. The driver computing devices 14(1)-14(n) can be mobile computing devices, smartphones, tablets, laptops, desktop computers, or any combination thereof. Motor vehicle drivers can use the driver computing devices 14(1)-14(n) to interface with the driver intervention device 12 to receive recommended interventions, view risk levels and other associated performance data, and/or perform other types and numbers of functions, as described and illustrated in more detail later.

The processor 34(1)-34(n) in each of the driver computing devices 14(1)-14(n) executes a program of stored instructions for one or more aspects of the present technology as described and illustrated by way of the examples herein. Other types and numbers of processing devices and configurable hardware logic could be used and the processor 34(1)-34(n) in each of the driver computing devices 14(1)-14(n) could execute other numbers and types of programmed instructions.

The memory 36(1)-36(n) in each of the driver computing devices 14(1)-14(n) stores these programmed instructions for one or more aspects of the present technology, as described and illustrated herein, although some or all of the programmed instructions could be stored and/or executed elsewhere. The memory 36(1)-36(n) optionally stores programmed instructions for a Web browser for communicating with the input/output device 38(1)-38(n) to operatively exchange content with the driver intervention device 12. A variety of different types of memory storage devices, such as a random access memory (RAM), read only memory (ROM), floppy disk, hard disk, CD-ROM, DVD-ROM, or other computer readable medium which is read from and written to by a magnetic, optical, or other reading and writing system that is coupled to the processor 34(1)-34(n), can be used for the memory 36(1)-36(n).

The input/output device 38(1)-38(n) in each of the driver computing devices 14(1)-14(n) is used to operatively couple and communicate between the driver computing device 14(1)-14(n) and the driver intervention device 12 via the communication network 18(1), although other types and numbers of connections or configurations can also be used.

The input device 40(1)-40(n) in each of the driver computing devices 14(1)-14(n) is used to enable a motor vehicle driver to interact with the driver computing device 14(1)-14(n), such as to input data or to configure, program, or operate the driver computing device 14(1)-14(n) by way of example only. Input devices may include a keyboard, computer mouse, or touchscreen, for example, although other types and numbers of input devices could also be used.

The display device 42(1)-42(1) in each of the driver computing devices 14(1)-14(n) is used to enable a user to view data and information output or provided by the driver computing device 14(1)-14(n). Display devices 42(1)-42(n) may include a computer monitor or a touchscreen, although other types and numbers of display devices could also be used.

The performance data source devices 16(1)-16(n) in this example each include a processor, a memory, and an input/output device, which are coupled together by a bus or other link. The performance data source devices 16(1)-16(n) can also have other numbers and types of systems, devices, components, and elements in other configurations and locations. In some examples, the performance data source devices 16(1)-16(n) include one or more server computing devices hosted by providers of performance data and/or one or more telematics devices, as described and illustrated in more detail later.

Although examples of the driver intervention device 12, driver computing devices 14(1)-14(n), and performance data source devices 16(1)-16(n), which are coupled together via the communication networks 18(1)-18(2), are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. The examples may also be implemented on computer device that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, or combinations thereof.

The examples may also be embodied as a non-transitory computer readable medium having programmed instructions stored thereon for one or more aspects of the present technology as described and illustrated by way of the examples herein. The programmed instructions, when executed by a processor, cause the processor to carry out the steps necessary to implement one or more methods of the examples, as described and illustrated herein.

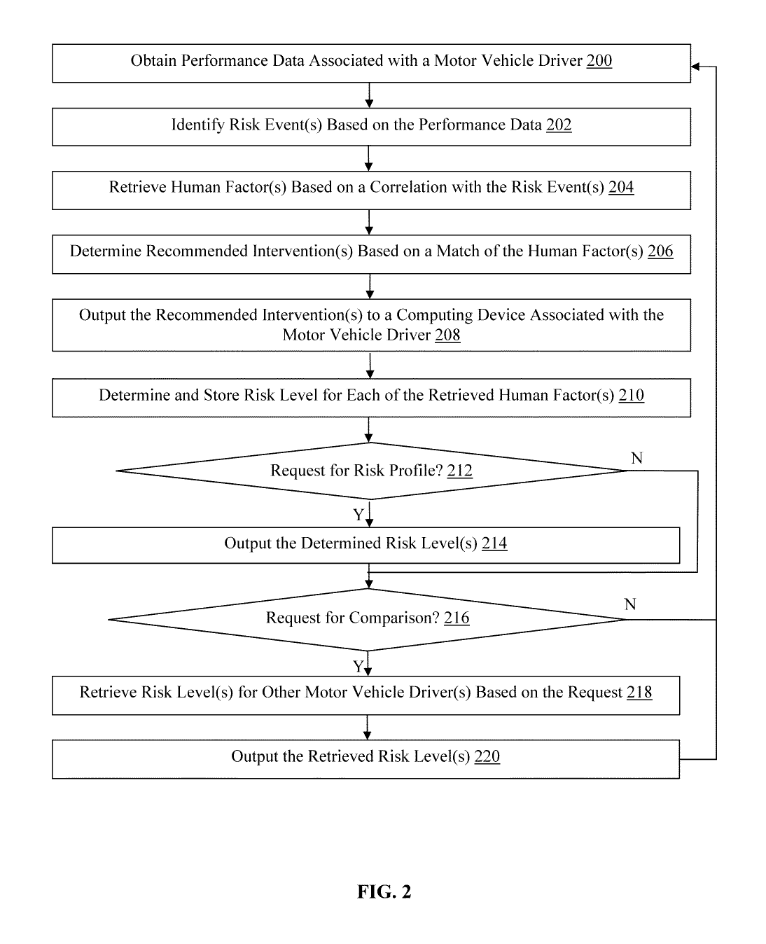

Exemplary methods and devices for facilitating motor vehicle driver risk reduction will now be described with reference to FIGS. 1-4. Referring more specifically to FIG. 2, in step 200 the driver intervention device 12 obtains performance data associated with a motor vehicle driver. In this example, the performance data is obtained from one or more of the performance data source devices 16(1)-16(n) using the input/output device 24 and communication network 18(2).

In one example, the performance data is obtained by the driver intervention device 12 periodically from the performance data source devices 16(1)-16(n). In another example, the performance data is obtained in response to a change in the performance data provided by one or more of the performance data source devices 16(1)-16(n), such as the reporting of a collision involving the motor vehicle driver, for example. In yet another example, the performance data is obtained in response to a request from the motor vehicle driver using one of the driver computing devices 14(1)-14(n). The performance data can also be obtained at other times and in other manners.

The performance data includes at least incident, collision, violation, and vehicle operation information, although other types and numbers of performance data can also be obtained in step 200. Accordingly, the performance data source devices 16(1)-16(n) in this example can include one or more server computing devices hosted by a government agency, such as a state department of motor vehicles and/or the Federal Motor Carrier Safety Administration, which are configured to store and selectively provide motor vehicle records and/or violations (e.g., road side inspection violations) for the motor vehicle driver.

One or more of the performance data source devices 16(1)-16(n) also can comprise a server computing device associated with an insurance company, broker, and/or leasing company, for example, which are configured to store and selectively provide claim information including incident and collision data for the motor vehicle driver. Additionally, one or more of the performance data source devices 16(1)-16(n) can comprise a telematics device attached to a computing device in a motor vehicle associated with the motor vehicle driver, and/or a server computing device hosted by a fleet vehicle operator associated with the motor vehicle driver which stores performance data output by the telematics device. The telematics device may be configured to transmit, and/or the server computing device may be configured to store and selectively provide, information regarding the operation of the motor vehicle associated with the motor vehicle driver.

The performance data source devices 16(1)-16(n) can also include other types and numbers of devices configured to store and/or provide other performance data to the driver intervention device 12 using the communication network 18(2). By obtaining at least incident, collision, violation, and vehicle operation information for the motor vehicle driver, the driver intervention device 12 can utilize a relatively comprehensive profile of performance data in order to generate more effective and targeted recommended interventions for the motor vehicle driver, as described and illustrated in more detail later. Optionally, the driver intervention device 12 stores the performance data obtained form the performance data source devices 16(1)-16(n) as associated with the motor vehicle driver in the memory 22, such as in the performance data database 32.

In step 202, the driver intervention device 12 identifies one or more risk events associated with the motor vehicle driver based on the performance data obtained in step 200. In order to identify any risk events, the driver intervention device 12 can filter the performance data retrieved from one or more of the performance data source devices 16(1)-16(n), for example, based on a configuration provided by an administrator of the driver intervention device 12. For example, the driver intervention device 12 can be configured by an administrator such that only speeding and braking event data retrieved from one of the performance data source devices 16(1)-16(n) providing telematics data will be considered risk events.

In other examples, each discrete portion of the performance data (e.g., each violation) obtained from one of the performance data source devices 16(1)-16(n) can be considered a risk event. Optionally, the administrator of the driver intervention device 12 can establish a default configuration and/or a configuration for each of a plurality of fleet vehicle operators, which is used to identify risk events for motor vehicle drivers associated with each of the fleet vehicle operators. Other methods of identifying any risk events from the performance data obtained in step 200 can also be used.

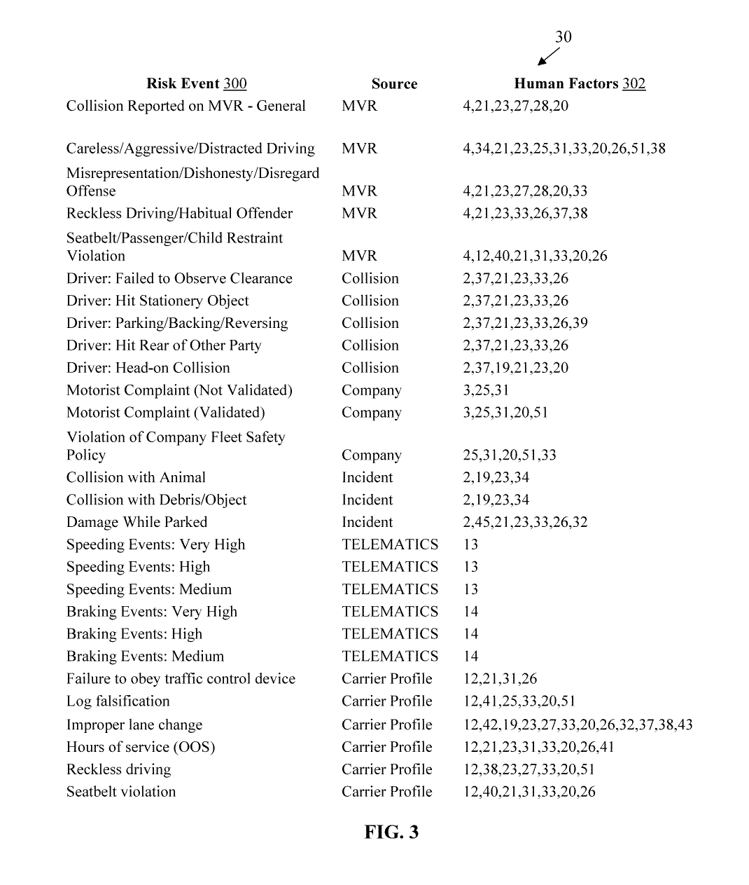

Referring to FIG. 3, exemplary content of the human factor mapping table 30 stored in the memory 22 of the driver intervention device 12 is illustrated. The human factor mapping table 30 can be established by an administrator of the driver intervention device 12, for example, and can include mappings of a risk event to a human factor associated with the risk event. In this example, the human factor mapping table 30 includes exemplary risk events 300, such as “Reckless Driving/Habitual Offender,” “Driver: Head-on Collision,” “Motorist Complaint (Validated),” “Damage While Parked,” “Speeding Events: Very High,” and “Improper lane change,” for example, although any other types and numbers of risk events can be included in the human factor mapping table 30.

Accordingly, the driver intervention device 12 can identify a risk event 300 in the human factor mapping table 30 in step 202 based on an analysis of the performance data obtained in step 200. For example, “Collision Reported on MVR—General” is a risk event that can be identified from motor vehicle record performance data provided by one of the performance data source devices 16(1)-16(n) associated with a state department of motor vehicles. In another example, “Driver: Head-on Collision” is a risk event that can be identified from collision or claims data provided by one of the performance data source devices 16(1)-16(n) associated with an insurance provider.

By obtaining performance data from multiple sources, including a state department of motor vehicles and an insurance provider in this example, the driver intervention device 12 can identify more collisions or other incidents associated with the motor vehicle driver. Accordingly, the driver intervention device 12 can identify more risk events for the motor vehicle driver, provide a more accurate risk analysis of the motor vehicle driver, and generate more effective intervention recommendation, as described and illustrated in more detail later. Optionally, the driver intervention device 12 stores the identified risk events as associated with the motor vehicle driver in the memory 22.

In step 204, the driver intervention device 12 retrieves a human factor based on a correlation with each of the risk events identified in step 202. More specifically, in this example the driver intervention device 12 can retrieve the human factor utilizing the human factor mapping table 30, although other manners for obtaining the human factor can be used. Referring back to FIG. 3, the exemplary human factor mapping table 30 includes a plurality of human factors 302 which are mapped to different risk events 300. The human factors can be human attributes or behaviors likely to contribute to a corresponding one or more of the risk events, for example.

Accordingly, the driver intervention device 12 can compare any risk events identified in step 202 with the risk events 300 in the human factor mapping table 30 to retrieve one or more human factors 302 associated with the identified risk events 300. Optionally, the human factors can be mapped to risk events based on historical, empirical, or other research-based data or any other analysis or correlation of human attributes and/or behaviors that contribute to risk events associated with motor vehicle drivers.

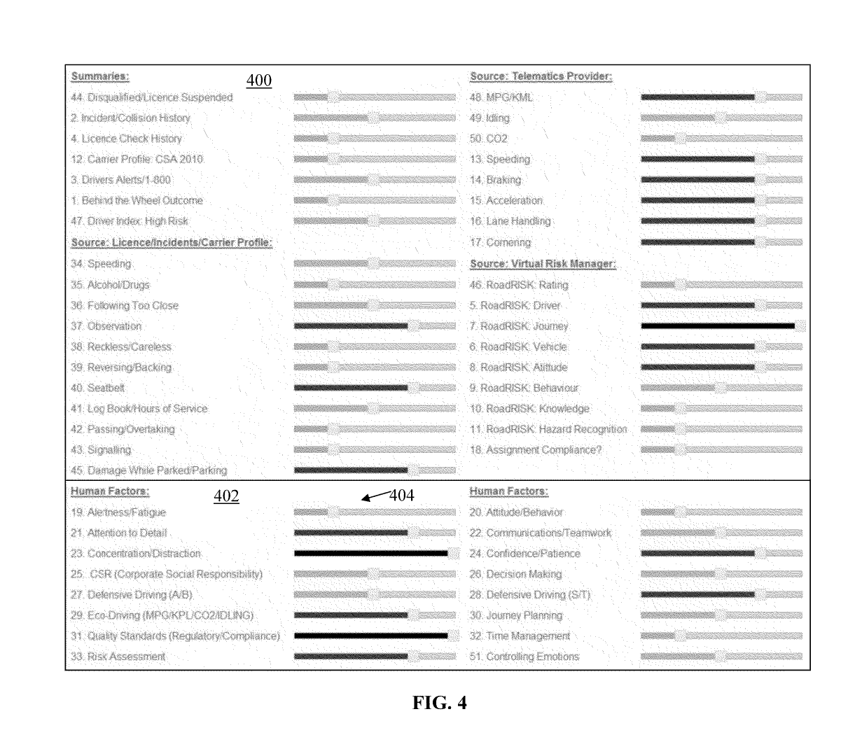

In this example, the human factor mapping table 30 includes human factors 302 identified by a number, although other types of identifiers could be used. In FIG. 4, an exemplary risk profile 400 including risk levels for risk events and human factors associated with the risk events is illustrated. The risk profile 400 includes exemplary human factors 402. In one example, referring back to FIG. 3, the “Collision with Animal” risk event is associated with human factors indicated by the numbers 2, 19, 23, and 34. Referring to FIG. 4, the human factors associated with the number 19 is “Alertness/Fatigue” and the human factor associated with the number 23 is “Concentration/Distraction” (the human factors associated with numbers 2 and 34 are not illustrated in FIG. 4 in this example).

Accordingly, a match of an identified “Collision with Animal” risk event results, in this example, in the driver intervention device 12 retrieving human factors 2, 19, 23, and 34 which including “Alertness/Fatigue” and “Concentration/Distraction,” with two others not shown. In other examples, the human factors 302 of the human factor mapping table 30 can be indicated directly without reference to a corresponding numerical value and other methods of storing the human factors in the human factor mapping table 30 can be used.

Referring back to FIG. 2, in step 206, the driver intervention device 12 determines one or more recommended interventions based on the one or more human factors retrieved from the correlation in step 204. In this example, the memory 22 of the driver intervention device 12 can determines one or more recommended interventions by mapping each of the one or more human factors to a recommended intervention stored in the intervention library 28. The recommended interventions stored in the intervention library 28 can include educational or training materials including written, audio, video, and/or other multimedia content, for example, although other types and numbers of recommended interventions can also be used. The recommended intervention stored in the intervention library 28 can be capable of addressing or improving many human factors or can be focused on a few or one of the human factors, for example.

Accordingly, the driver intervention device 12 can map each of the one or more human factors retrieved in step 204 to a recommended intervention stored in the intervention library 28 to determine the one or more recommended interventions for the motor vehicle driver. An example of a recommended intervention determined for the “Alertness/Fatigue” human factor in step 206 could be a training video regarding improving sleep and/or maintaining healthy sleep patterns. Accordingly, the recommended intervention could help the motor vehicle driver improve the “Alertness/Fatigue” human factor that may have contributed to the “Collision with Animal” risk event.

In step 210, the driver intervention device 12 outputs the one or more recommended interventions to the corresponding one of the driver computing devices 14(1)-14(n) associated with the motor vehicle driver. The one or more recommended interventions output by the driver intervention device 12 can include the content itself for the recommended intervention or a link to the content for the recommend intervention stored in the intervention library 28, although other manners for providing the content of the recommend intervention could be used. In examples in which many recommended interventions are determined, the recommended interventions can be output as part of a risk reduction plan for the motor vehicle driver.

The recommended interventions could also be output by the driver intervention device 12 based on settings established by an administrator and/or contact information for the motor vehicle driver retrieved from one of the driver computing devices 14(1)-14(n) associated with the motor vehicle driver and stored in the memory 22, for example. The settings can define a default method of outputting the recommended interventions to the motor vehicle driver, such as by e-mail or text message, for example.

In other examples, the driver intervention device 12 can output the one or more recommended interventions in response to a request submitted by the motor vehicle driver using one of the driver computing devices 14(1)-14(n). In these examples, the motor vehicle driver can login to the driver intervention device 12 to request the recommended intervention(s) which can be sent to the one of the driver computing devices 14(1)-14(n) as part of a graphical display and/or web page using the communication network 18(1), for example. Other methods of outputting the recommended intervention(s) can also be used.

In some examples, the driver intervention device 12 periodically performs steps 200-208 for a plurality of motor vehicle drivers, such as motor vehicle drivers associated with an organization. In these examples, the driver intervention device can output recommended interventions to the motor vehicle drivers in response to identifying a risk event in the obtained performance data, although the recommend interventions can be output in other manners, such as to a supervisor or manager of the motor vehicle drivers who can then follow up with each one.

Accordingly, as illustrated with this example a motor vehicle driver can receive recommended interventions promptly subsequent to the occurrence of a risk event. Additionally, the recommended interventions can be targeted to addressing or improving the one or more human factors that may have contributed to the risk event. As a result, with this technology the risk of a future similar event occurring for the motor vehicle drivers is reduced along with the overall risk of any organization associated with the driver.

Optionally, in step 210, the driver intervention device 12 determines a risk level for each of the human factors retrieved in step 204. The risk levels can reflect the likelihood or level of risk that the human factor will contribute to a future risk event associated with the motor vehicle driver. In one example, the risk level for a human factor can be based on the number of times the human factor was retrieved in step 204 based on a correlation with one of the risk events identified in step 202. Accordingly, if the “Alertness/Fatigue” human factor was retrieved a relatively high number of times based on its correlation with a relatively high number of identified risk events, then the risk level for that human factor would be relatively high.

Optionally, the driver intervention device 12 can be configured to decrease the risk level for a human factor incrementally as the period of time without a risk event associated with the human factor has elapsed. Additionally, other methods of determining and adjusting the risk level for each of the retrieved human factor(s) can be used. The driver intervention device 12 can store the determined risk levels and corresponding human factors in the memory 22 as associated with the motor vehicle driver, for example.

In step 212, the driver intervention device 12 determines whether a request has been received for a risk profile for the motor vehicle driver. The request can be received from a motor vehicle driver using one of the driver computing devices 14(1)-14(n) or from a computing device associated with a representative of a fleet vehicle operator or other organization, for example. The request can be received through a web interface provided by the driver intervention device 12, for example, although other methods of receiving a request for a risk profile can also be used. If the driver intervention device 12 determines it has received a request for a risk profile for the motor vehicle driver, then the Yes branch is taken to step 214.

In step 214, the driver intervention device 12 outputs one or more of the risk levels determined in step 210. The risk levels can be retrieved from the memory 22, for example. The request received in step 212 in this example can include parameters, such as an indication of a motor vehicle driver or one or more human factors for which the risk levels are to be retrieved. Optionally, the risk levels are output to a graphical display including the risk profile 400 as illustrated in FIG. 4. In this example, a risk level 404 is graphically indicated next to each of the human factors 402. The risk profile 400 can be included on a web page, for example, which is generated and output by the driver intervention device 12.

In the exemplary risk profile 400, the risk levels 404 are indicated using slider bars. In this example, a motor vehicle driver can manually interact with one of the sliders using one of the input devices 40(1)-40(n) of one of the driver computing devices 14(1)-14(2) to input to the driver intervention device 12 a higher risk level for one of the human factors, for example. Upon receiving the input, the driver intervention device 12 may output to the corresponding one of the driver computing devices 14(1)-14(n) a recommended intervention for the higher risk level associated with a human factor from the intervention library 28. Again the output recommended intervention can be associated with content directed to improving the associated human factor with the higher risk level to reduce the risk that the human factor will contribute to a subsequent risk event for the motor vehicle driver.

Accordingly, in addition to the automated method of outputting recommended interventions described and illustrated earlier with reference to steps 200-208, a motor vehicle drive can manually initiate or otherwise trigger the output of recommended interventions by the driver intervention device 12 using the slider bars in this example. Other types of risk profiles and user inputs and other methods of outputting recommended interventions in response to an input from a motor vehicle driver can also be used. Additionally, the risk profile 400 output in step 214 can include other risk ratings, levels, and/or scores based on the risk events identified in step 202 or any other data.

Subsequent to outputting the one or more determined risk levels in step 214 or if the driver intervention device 12 determined that a request for a risk profile has not been received and the No branch was taken from step 212, then the driver intervention device 12 proceeds to step 216. In step 216, the driver intervention device 12 determines whether it has received a request for a comparison of the motor vehicle driver to one or more other motor vehicle drivers sharing a characteristic with the motor vehicle driver.

The request can be received from a motor vehicle driver using one of the driver computing devices 14(1)-14(n) or from a computing device associated with a representative of a fleet vehicle operator or other organization, for example. The request can be received through a web interface provided by the driver intervention device 12, for example, although other methods of receiving a request for a comparison of the motor vehicle driver can also be used. If the driver intervention device 12 determines it has received a request for a comparison of the motor vehicle driver, then the Yes branch is taken to step 218.

In step 218, the driver intervention device 12 retrieves one or more of the risk levels determined and stored in the memory 22 in step 210 for one or more motor vehicle drivers based on parameters included in the request. In this example, steps 202-210 can be performed for a plurality of motor vehicle drivers, such as all drivers associated with an organization for example. Accordingly, one of the motor vehicle drivers or a representative of the organization can submit a request for a comparison of one or more of the motor vehicle drivers to one or more other of the motor vehicle drivers. The request can include one or more parameters including one or more shared characteristics of the drivers (e.g., an indication of an organization, a geographic area, or a demographical attributes), as well as an indication of a subset of the human factors, that can be used by the performance management to retrieve the one or more risk levels responsive to the request.

In step 220, the driver intervention device 12 outputs the one or more risk levels retrieved in step 218 in response to the request. The one or more risk levels can be output to a graphical display, such as a web page for example, that is sent to the requesting one of the driver computing devices 14(1)-14(n) or computing device associated with a representative of an organization, for example. Optionally, the data output in step 220 can be processed such as to anonymize the data based on the permission of the requesting user and/or to generate an average, median, or mean for one or more of the risk levels, for example. Other methods of processing the data and other methods of outputting a comparison of motor vehicle driver risk levels can also be used.

Subsequent to outputting the retrieved one or more risk levels in step 220, or if the driver intervention device 12 determines that a request for a comparison of motor vehicle drivers has not been received and the No branch was taken from step 216, then the driver intervention device 12 proceeds back to step 200. In step 200, the driver intervention device 12 can obtained performance data associated with a motor vehicle driver, as described and illustrated earlier.

Accordingly, with this technology a comprehensive profile of performance data including incidents, collisions, violations, and vehicle operation data can be obtained for motor vehicle drivers and used to generate targeted recommended interventions focused on improving human factors that contributed to risk events identified in the performance data. Additionally, with this technology, motor vehicle drivers can utilize the recommended interventions to reduce the risk that a future risk event will occur. Further, the motor vehicle driver or a representative of an organization, such as a fleet vehicle operator, can more effectively analyze risk by advantageously comparing risk levels associated with human factors for various motor vehicle drivers sharing one or more characteristics.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A method for motor vehicle driver risk reduction, the method comprising:
obtaining, by a driver intervention device, an indication of each of a plurality of risk events associated with a motor vehicle driver for a historical period of time;
retrieving, by the driver intervention device, a plurality of human factors of the motor vehicle driver based on a correlation of the human factors with one or more of the risk event indications in a human factor mapping table;
determining, by the driver intervention device, a risk reduction plan comprising a plurality of recommended interventions for the motor vehicle driver based on a correlation of each of the recommended interventions with one or more of the human factors, the human factors each comprising an indication of an attribute of the motor vehicle driver that contributed to one or more of the risk events;
determining, by the driver intervention device, a plurality of risk levels each associated with one of the human factors based on a number of correlations of each of the human factors with one of the risk events, wherein the risk levels each reflect a likelihood that the associated one of the human factors will contribute to a future risk event associated with the motor vehicle driver; and
outputting, by the driver intervention device, the risk reduction plan and one or more of the risk levels in response to one or more received requests.

2. The method of claim 1, wherein:
the recommended interventions of the risk reduction plan are selected based on a correlation of the recommended interventions with one or more of the human factors having a higher associated risk level than one or more other of the human factors; and
the outputting further comprises outputting the determined risk reduction plan to a computing device associated with the motor vehicle driver.

3. The method of claim 1, further comprising:
outputting, by the driver intervention device, the risk levels in response to a request received from a fleet vehicle operator associated with the motor vehicle driver.

4. The method of claim 3, further comprising:
retrieving, by the driver intervention device, a risk level for one or more human factors for each of one or more other motor vehicle drivers sharing a characteristic with the motor vehicle driver; and
outputting, by the driver intervention device, one or more of the determined plurality of risk levels and the retrieved risk level for the one or more human factors for each of the one or more other motor vehicle drivers in response to a received request for a comparison of the motor vehicle driver to the one or more other motor vehicle drivers.

5. The method of claim 1, wherein the risk event is an incident, a collision, or a violation and the obtaining further comprises:
obtaining performance data associated with the motor vehicle driver from one or more performance data source devices; and
identifying the risk event based on the performance data.

6. The method of claim 5, wherein the performance data comprises at least one or more motor vehicle records for the motor vehicle driver, road side inspection data for the motor vehicle driver, telematics data retrieved from a motor vehicle associated with the motor vehicle driver, or one or more insurance claim records associated with the motor vehicle driver.

7. The method of claim 1, wherein the at least one recommended intervention comprises educational, informational, or training material comprising written, audio, or video content or a link to the educational, informational, or training material.

8. A non-transitory computer readable medium having stored thereon instructions for motor vehicle driver risk reduction comprising machine executable code which when executed by a processor, causes the processor to perform steps comprising:
obtaining an indication of each of a plurality of risk events associated with a motor vehicle driver for a historical period of time;
retrieving a plurality of human factors of the motor vehicle driver based on a correlation of the human factors with one or more of the risk event indications in a human factor mapping table;
determining a risk reduction plan comprising a plurality of recommended interventions for the motor vehicle driver based on a correlation of each of the recommended interventions with one or more of the human factors, the human factors each comprising an indication of an attribute of the motor vehicle driver that contributed to one or more of the risk events;
determining a plurality of risk levels each associated with one of the human factors based on a number of correlations of each of the human factors with one of the risk events, wherein the risk levels each reflect a likelihood that the associated one of the human factors will contribute to a future risk event associated with the motor vehicle driver; and
outputting the risk reduction plan and one or more of the risk levels in response to one or more received requests.

9. The medium of claim 8, wherein:
the recommended interventions of the risk reduction plan are selected based on a correlation of the recommended interventions with one or more of the human factors having a higher associated risk level than one or more other of the human factors; and
the outputting further comprises outputting the determined risk reduction plan to a computing device associated with the motor vehicle driver.

10. The medium of claim 8, further having stored thereon instructions that when executed by the processor cause the processor to perform steps further comprising:
outputting the risk levels in response to a request received from a fleet vehicle operator associated with the motor vehicle driver.

11. The medium of claim 10, further having stored thereon instructions that when executed by the processor cause the processor to perform steps further comprising:
retrieving a risk level for one or more human factors for each of one or more other motor vehicle drivers sharing a characteristic with the motor vehicle driver; and
outputting one or more of the determined plurality of risk levels and the retrieved risk level for the one or more human factors for each of the one or more other motor vehicle drivers in response to a received request for a comparison of the motor vehicle driver to the one or more other motor vehicle drivers.

12. The medium of claim 8, wherein the risk event is an incident, a collision, or a violation and the obtaining further comprises:
obtaining performance data associated with the motor vehicle driver from one or more performance data source devices; and
identifying the risk event based on the performance data.

13. The medium of claim 12, wherein the performance data comprises at least one or more motor vehicle records for the motor vehicle driver, road side inspection data for the motor vehicle driver, telematics data retrieved from a motor vehicle associated with the motor vehicle driver, or one or more insurance claim records associated with the motor vehicle driver.

14. The medium of claim 8, wherein the at least one recommended intervention comprises educational, informational, or training material comprising written, audio, or video content or a link to the educational, informational, or training material.

15. A driver intervention device, comprising:
a processor coupled to a memory and configured to execute programmed instructions stored in the memory comprising:
obtaining an indication of each of a plurality of risk events associated with a motor vehicle driver for a historical period of time;
retrieving a plurality of human factors of the motor vehicle driver based on a correlation of the human factors with one or more of the risk event indications in a human factor mapping table;
determining a risk reduction plan comprising a plurality of recommended interventions for the motor vehicle driver based on a correlation of each of the recommended interventions with one or more of the human factors, the human factors each comprising an indication of an attribute of the motor vehicle driver that contributed to one or more of the risk events;
determining a plurality of risk levels each associated with one of the human factors based on a number of correlations of each of the human factors with one of the risk events, wherein the risk levels each reflect a likelihood that the associated one of the human factors will contribute to a future risk event associated with the motor vehicle driver; and
outputting the risk reduction plan and one or more of the risk levels in response to one or more received requests.

16. The device of claim 15, wherein:
the recommended interventions of the risk reduction plan are selected based on a correlation of the recommended interventions with one or more of the human factors having a higher associated risk level than one or more other of the human factors; and
the outputting further comprises outputting the determined risk reduction plan to a computing device associated with the motor vehicle driver.

17. The device of claim 15, wherein the processor is further configured to execute programmed instructions stored in the memory further comprising:
outputting the risk levels in response to a request received from a fleet vehicle operator associated with the motor vehicle driver.

18. The device of claim 17, wherein the processor is further configured to execute programmed instructions stored in the memory further comprising:
retrieving a risk level for one or more human factors for each of one or more other motor vehicle drivers sharing a characteristic with the motor vehicle driver; and
outputting one or more of the determined plurality of risk levels and the retrieved risk level for the one or more human factors for each of the one or more other motor vehicle drivers in response to a received request for a comparison of the motor vehicle driver to the one or more other motor vehicle drivers.

19. The device of claim 15, wherein the risk event is an incident, a collision, or a violation and the obtaining further comprises:
obtaining performance data associated with the motor vehicle driver from one or more performance data source devices; and
identifying the risk event based on the performance data.

20. The device of claim 19, wherein the performance data comprises at least one or more motor vehicle records for the motor vehicle driver, road side inspection data for the motor vehicle driver, telematics data retrieved from a motor vehicle associated with the motor vehicle driver, or one or more insurance claim records associated with the motor vehicle driver.

21. The device of claim 15, wherein the at least one recommended intervention comprises educational, informational, or training material comprising written, audio, or video content or a link to the educational, informational, or training material.
